(19) United States
(12) Patent Application Publication
(10) Pub. No.: US 2004/0117760 A1
(43) Pub. Date: Jun. 17, 2004

(54) Reality-based optimization

(75) Inventor: Scott McFarling, Redmond, WA (US)

Correspondence Address: KLARQUIST SPARKMAN LLP, 121 S.W. SALMON STREET, SUITE 1600, PORTLAND, OR, 97204, US

(73) Assignee: Microsoft Corporation

(21) Appl. No.: 10/317,604

(22) Filed: Dec. 11, 2002

(51) Int. Cl. G06F 9/44; G06F 9/45

(52) U.S. Cl. 717/101; 717/151

(57) ABSTRACT

The present invention provides a method for optimizing software by using scenario data along with user data collected from real use of the software by a number of real users. The instrumented version of software is distributed to a number of real users such that user data can be collected that reflects a more complete coverage of the program than traditional scenario data. Due to the time necessary to collect user data from real users, the user data from a previous build of the program can be propagated so that it will accurately predict the behavior of the current build of a program. Additionally, a method of limiting the amount of user data collected from the real users is provided such that the amount of user data can be limited without decreasing either the amount of coverage of the user data or its accuracy.

### TECHNICAL FIELD

The following invention relates to the optimization of software, and more particularly, to reality-based optimization of software using both scenario data and user data from real users.

### BACKGROUND

A compiler is a computer program used to convert source code written by a programmer into computer-readable and executable object code. The object code, or executable file, is then distributed to users. Modern compilers are designed such that the executable file is somewhat optimized based on provided profile data that suggests how the executable file will behave when executed.

Numerous examples of optimization using profile data exist including Bala, V., Duesterwald, E., and Banerjia, S., Dynamo: A Transparent Run-time Optimization System, PLDI, June 2000; Cohn, R., Goodwin, D., Lowney, P. G., Optimizing Alpha Executables on Windows NT with Spike, Digital Technical Journal, March, 1997; Hashemi, A., H., Kaeli, D., R., and Calder, B., Efficient Procedure Mapping using Cache Line Coloring, June, 1997; McFarling, S., Program Optimization for Instruction Caches, ASPLOS-III, April 1989; McFarling, S., Procedure Merging with Instruction Caches, PLDI, June 1991; McFarling, S., Hennessy, J., Reducing the Cost of Branches, ISCA, June, 1986; Torrellas, J., et al., Optimizing Instruction Cache Performance for Operating System Intensive Workloads, HPCA, January, 1995; Wang, Z., Rubin, N., Evaluating the Importance of User-Specific Profiling, The 2nd USENIX Windows NT Symposium, August 1998; Wang, Z., Progressive Profiling: A Methodology Based on Profile Propagation and Selective User Collection, Ph.D. Thesis, Harvard University; and Zhang, X. et al., System Support for Automatic Profiling and Optimization, SOSP, 1997.

For example, the Cohn reference describes using a program called Spike in order to optimize executables. Spike provides a Spike Optimization Environment (SOE) that allows a programmer to select an application to instrument. An instrumented application refers to an application modified to produce profile data possibly including which blocks of code are used, how often they are used, recognizable patterns of block usage, common patterns of accessing data, etc. Once an application is chosen to be instrumented, SOE thereafter executes the instrumented version of the program whenever the programmer requests execution of the original program. Profile data resulting from the execution of the instrumented version is stored in a database until such time as the programmer requests the program be optimized. SOE will then optimize the application using the profile data collected. The Spike Optimizer parses the application executable into an intermediate representation that can be readily analyzed. The optimizer rewrites the intermediate representation of the application based on the profile data and produces a new, optimized executable. The optimized application is then placed in the database where it can be compared to the original by the programmer if they so desire.

Executable files created in such a fashion are often not as optimized as desired. Profile data is generated by programmer execution of the program, or by using scenarios, automated test scripts, benchmarks, or pre-selected workloads authored by a programmer to drive the instrumented application. Because the sizes of modern applications are becoming increasingly large, and functionality increasingly more complex, a complete set of scenarios is difficult, if not impossible, to obtain. A limited amount of scenarios cannot simulate the vast variances in the way modern users of computer software will use the software. For example, desktop applications can execute vastly different code paths depending on seemingly minor factors such as mouse location or the position the application sits on the screen relative to other applications that may be running.

Additionally, the time allowed for optimization of software from build to build is often limited to hours, if not minutes. The inadequate coverage of scenarios is therefore aggravated by the small amount of time available to run the scenarios on the instrumented version of the program. Time is also consumed creating scenarios to drive the program.

These factors cause the final executable to be less efficient because some major functions will be executed, while leaving others unexecuted and therefore uncovered. FIG. 1 shows the locations of the blocks of code prior to optimization 101 and also ideal locations of blocks of code after optimization 102. The individual blocks of code 103 before optimization are located without regard to the order or frequency of use. After optimization, ideally the blocks of code 103 that are used most frequently, or used in proximate time with each other, are positioned in proximity to one another on the same or adjacent memory pages, so that memory pressure on the system running the program will be reduced and fewer page faults will occur.

FIG. 2 shows the typical locations of blocks of code when profile data is lacking in coverage, and uncovered blocks of code 201 that are used by real users are located adjacent blocks of code that are rarely used 202 instead of with covered blocks of code 203 where they would ideally be placed. As a result, jumping to the uncovered blocks of code 201 from the covered blocks of code 203 is likely to cause increased memory pressure and require more frequent disk reads during execution.

### SUMMARY

The reality-based optimization technique described herein provides a method for optimizing software that overcomes the shortcomings of prior methods that use only scenario data. For purposes of clarity, profile data taken from an instrumented version of a program run by the programmer or developer, or an instrumented version of a program driven by programmer-authored scenarios, test cases, workloads, scripts, etc., will hereafter be referred to as scenario data. The term user data will refer to a different approach disclosed herein that reflects a more complete coverage of the program and does not suffer from the above-described infirmities of traditional scenario data.

In order to obtain user data, an instrumented version of a program is distributed to and run by a number of real users, as shown in FIG. 4, for an extended time period as compared to the time period scenarios are generally run on instrumented versions of software. The individual data from each user will be collected and aggregated, forming a substantially larger amount of data than is typical of traditional scenario data. This data will be reduced using unique data reduction techniques disclosed herein and then propagated to the current build of the program. The user data from real users is then combined with traditional scenario data and provided to an optimizer within a compiler. The software is then optimized and compiled to produce an optimized version of the program that is more effective than prior techniques in optimizing software performance.

The reality-based optimization technique described herein provides a method of optimization such that user data taken from a previous build of the software can be used with the current build of the software. As mentioned previously, collecting real user data can often take a far greater amount of time than collecting scenario data depending on the number of users the instrumented version is distributed to. During this time, the software is being revised. It would be undesirable to delay revision of the software while data is being collected from the users who were distributed the instrumented version of the software, or to have to re-collect data for each new build of the software. Therefore, the disclosed optimization technique utilizes a binary matching technique to propagate data taken from a previous build of the software such that it will accurately predict the behavior of the current build of the software. Propagation of the user data eliminates the need to stall revision of programs during data collection or to obtain new data when revisions are made to the build distributed to the real users. The end result is that software developers may ship products immediately after the final changes are made without having to wait while extensive user data is collected.

The reality-based optimization technique described herein also provides a method of limiting the amount of user data collected or retained from the real users. Real user data from even a small amount of users over time can create extremely large amounts of data, possibly thousands of times more data than the traditional amount of scenario data used to optimize a program. Therefore, it is advantageous to limit the amount of data collected or retained so that the storage space for the data and amount of data provided to the optimizer can be minimized without decreasing either the amount of coverage of the user data or its accuracy. This is accomplished by limiting the collection of user data to only those blocks of software not covered by scenario data or user data from other sources, as well as utilizing a unique data reduction technique such that less than all of the user data collected is actually provided to the optimizing compiler.

The reality-based optimization technique described herein also provides a method of combining the user data and scenario data in a phased manner such that the executable file produced is most efficient. The software the programmer wishes to optimize using reality-based optimization techniques desirably has already been somewhat optimized using traditional optimization techniques so that the user data taken from the number of real users more accurately describes the behavior of the optimized version of the software rather than a completely unoptimized version. Therefore, the scenario data and user data are combined in such a way as to ensure the optimizer considers the scenario data first in optimizing the program, and then subsequent to the scenario data, considers the user data in optimizing the program.

These and other aspects will become apparent from the following detailed description, which makes references to the accompanying drawings.

### BRIEF DESCRIPTION OF THE DRAWINGS

FIG. 1 shows the ideal resulting locations of blocks of code after optimization.

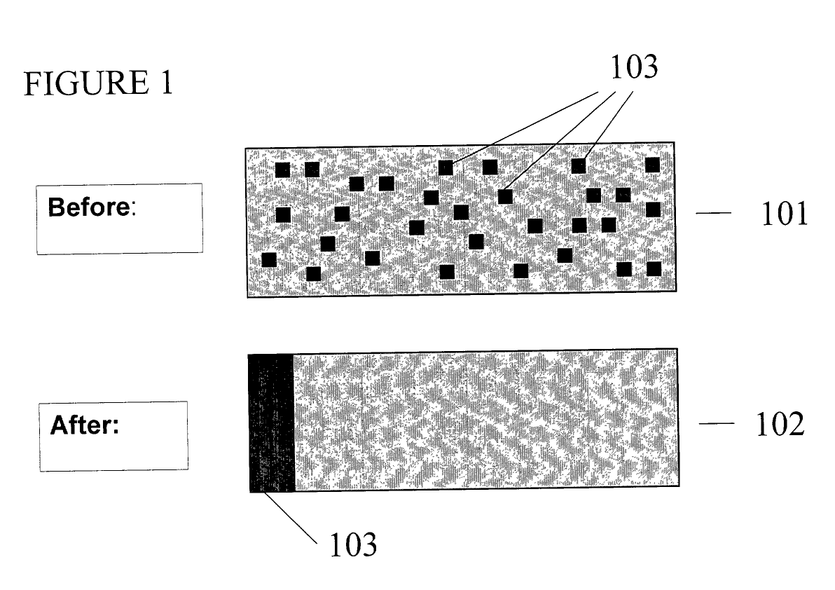

FIG. 2 shows the typical resulting locations of blocks of code using the prior art optimization.

FIG. 3 shows instrumented versions of software being distributed to a number of real users for execution.

FIG. 4 is a block diagram of a reality-based optimization system using real user data to optimize software.

FIG. 5 is a data flow diagram of an embodiment of a reality-based optimization technique using real user data to optimize software.

FIG. 6 shows reducing the amount of user data by keeping whole intervals of user data up to a predetermined number of intervals.

FIG. 7 shows reducing the amount of user data by removing intervals that contain no user data regarding block usage.

FIG. 8 shows reducing the amount of user data by setting a limit on the amount of user data to use for each block of code.

FIG. 9 is a data flow diagram of an embodiment of reality-based optimization of software.

FIG. 10 is a block diagram of a computer system that serves as an operating environment for an implementation of the invention.

### DETAILED DESCRIPTION

The reality-based optimization technique described herein encompasses methods, systems, and software development tools or utilities that perform improved optimization of software code by using real user data in addition to developer-constructed scenario data. For purposes of demonstrating the technique's efficacy, the disclosed technique was applied to four major dynamic link library (DLL) files from large, popular desktop applications using 12 real users executing the instrumented version of the program for a minimum of two weeks. The data collected was reduced using techniques described herein and combined with scenario data in a phased format also described herein. Observed memory pressure during run-time of the applications, measured in total live pages, was reduced by 29.2%, and observed disk reads were reduced by 33.3%, when compared to the same applications at run-time optimized using scenario data alone.

### Reality-Based Optimization

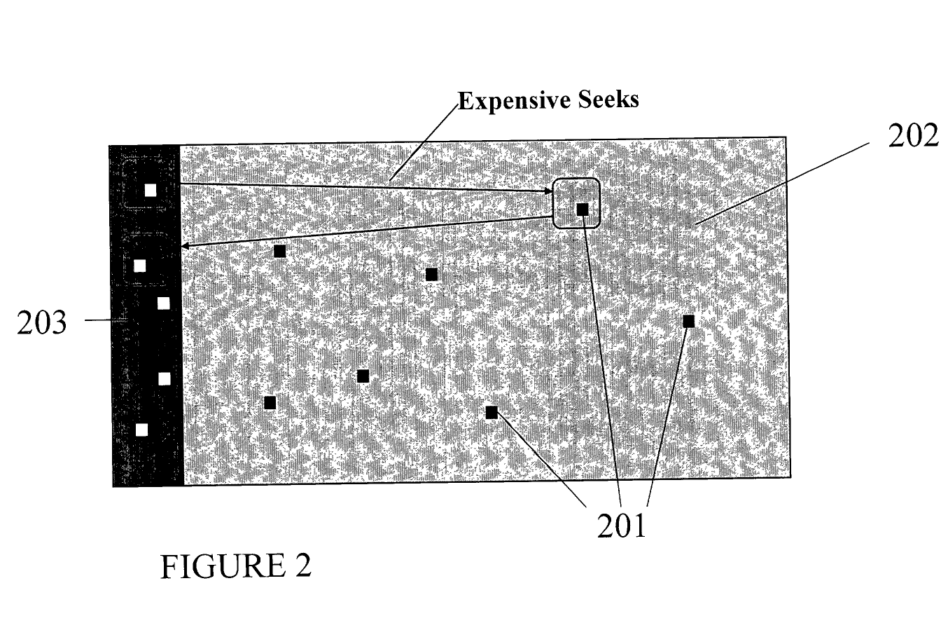

The disclosed reality-based optimization technique provides a method for optimizing software that provides for better coverage of blocks of code by using both user data from real users and scenario data in combination. Using both user data and scenario data in combination provides substantially more coverage of blocks than using scenario data alone, particularly the less frequently used blocks of code left uncovered when using only scenario data that cause more frequent page faults and poor memory management as demonstrated in FIG. 2.

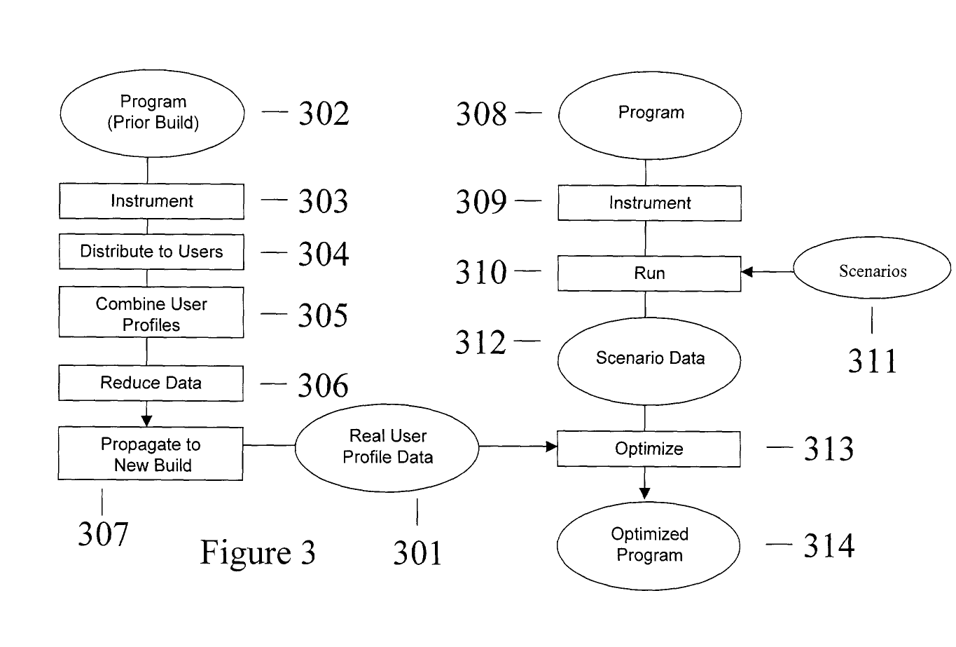

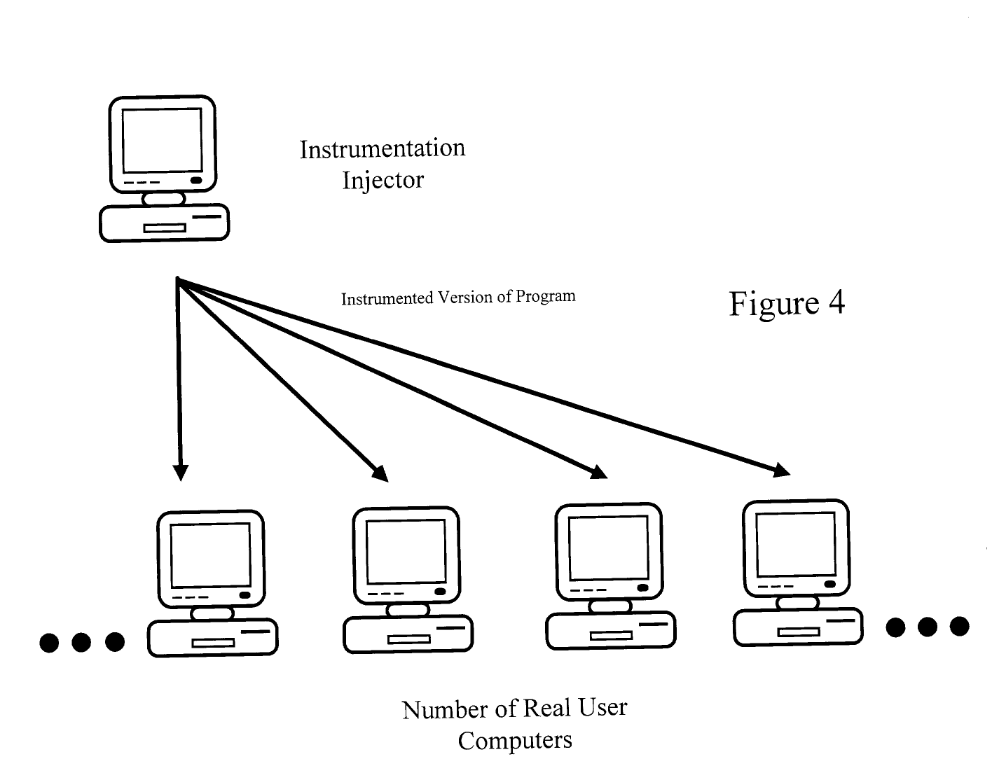

A data flow diagram is provided in FIG. 3 of data flow through one embodiment of a system for performing reality-based optimization. A build of the program 302 is instrumented 303 and distributed to a number of real users 304. An instrumented version of software is a version modified such that data describing the behavior of the program at run-time is monitored and data such as which blocks of code are used, how often they are used, recognizable patterns of block usage, common patterns of accessing data, etc, is collected, usually in the form of a log file. FIG. 4 shows an instrumentation injector used to add instrumentation to a build of software, and then distributing that instrumented build to a number of real users who then execute the instrumented version on their respective computers. The users are given a length of time to use the program on various computers in a normal fashion as an end user would in order to create data describing the behavior of blocks of code within the program at run-time. Referring again to FIG. 3, this data is collected and combined 305 to form user data 301. The user data 301 is then reduced 306 to a size that is manageable by the optimizer and by the storage device used to collect the data using the methods that will be described further under a separate heading.

During the given length of time for user execution of the program, the build of the program 302 instrumented and distributed 304 to the real users has most likely been revised and updated. Thus, the build of the program 302 distributed to the real users is probably outdated and considered a prior build by the time user data is ready to be used to optimize the current build of the program 308. Therefore, the user data 301 formed by combining the data collected from the execution of the distributed version of the program must be propagated 307 to the current build 308 so that the program can be concurrently revised while user data is being gathered. Profile Propagation is described further under a separate heading.

Once user data has been reduced and propagated 307 to the current build, the current build of the program 308 is instrumented 309. The instrumented version of the current build of the software is then run 310 with traditional, programmer-authored scenarios 311 such that scenario data 312 is created describing the behavior of the program at run-time for the given scenarios 311. The user data 301 and scenario data 312 are then used to optimize 313 the current build of the software 308. This code is then compiled 314 in order to form a final, optimized executable.

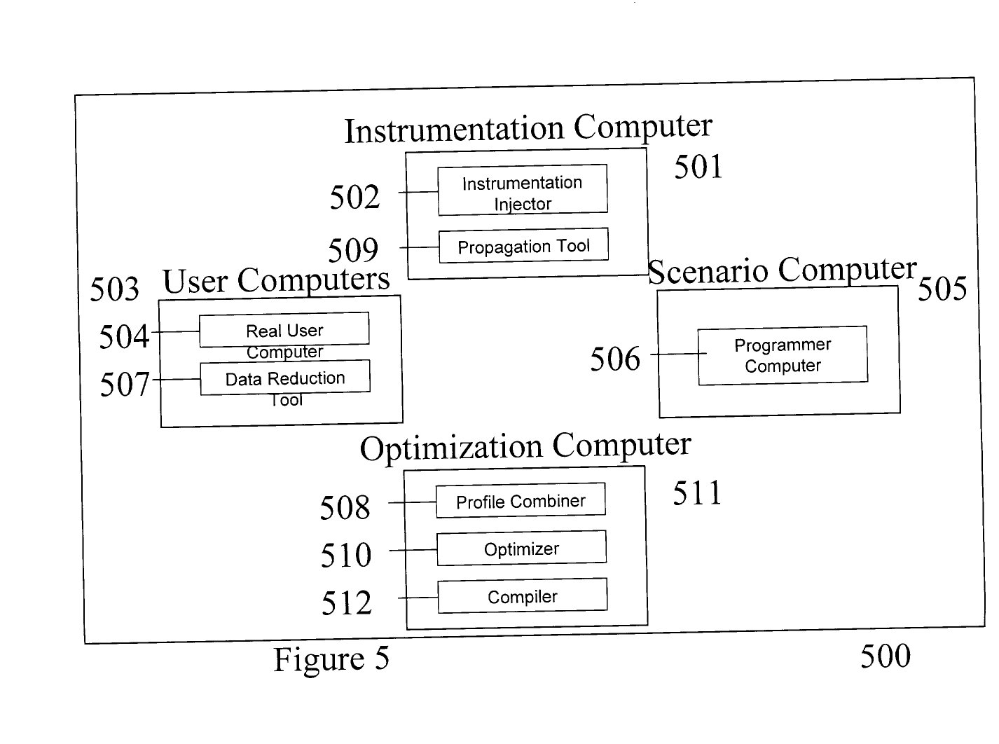

FIG. 5 shows one implementation of a system for performing reality-based optimization as illustrated in FIGS. 3 and 4. In the system 500, an instrumenting computer 501 includes an instrumentation injector 502 to produce an instrumented version of the software for distribution to a number of user computers 503, such as a real user's computer 504, and also provides an instrumented version of a subsequent build of the software to a scenario computer 505, such as the programmer's computer 506. Real users are provided a number of user computers 503 in order to execute copies of the instrumented version of the software. A data reduction tool 507 is provided to reduce the user data collected from the number of user computers 503 to a smaller size to allow for easier storage and processing of the data. A profile combiner 508 is used to combine the data such that the data describes the behavior of the instrumented versions on the various user computers 503. The scenario computer 505 executes the instrumented version of the software based on scenarios such that data is collected describing the behavior of the software under the scenarios. A profile propagation tool 509 is utilized to propagate data so that the data will describe the subsequent build of software. An optimizer 510 takes as input the user data from the user computers 503, the data from the scenario computer 505, and the source code of the subsequent build of the software and optimizes the source code based on the data provided by the scenario computer 505 and the user computers 503. A compiler 512 is then provided to produce a final executable from the optimized source code.

### Limiting Collection of User Data

One draw back of distributing an instrumented version of a program to a number of users to collect user data 301 is that much of the data may be repetitive both of other users as well as repetitive of the information available in scenario data 312. Therefore, the user data 301 from the number of real users can be limited to only such user data 301 that is anticipated will be needed by the compiler at optimization. One method for limiting the user data 301 collected is to only collect user data 301 from those blocks that need to be covered, i.e. not already covered either by previous user data 301 or by scenario data 312. This technique not only limits the amount of data collected, but also greater increases the run time of the instrumented programs. This is particularly advantageous in situations where the instrumented program is being used in normal day-to-day tasks where a large slow down would be a large inconvenience. Alternatively, another method for limiting the user data is to collect data for all blocks and then filter out the data relating to blocks already covered either by previous user data 301 or by scenario data 312.

To illustrate, consider a program with blocks of code 1-10. When the author of the scenarios 311 executes the instrumented version of the program, he may have collected all the necessary data to sufficiently cover blocks 1-7. Therefore, user data 301 on blocks 1-7 would be repetitive and unnecessary in order to optimize the program. In such a situation, user data 301 collected from the instrumented version of the program distributed to the real users can be limited to only blocks 8-10. Alternatively, user data 301 can be collected for blocks 1-10 and then user data 301 for blocks 1-7 can be discarded.

### User Data Reduction

Another draw back of using real user data 301 to optimize software is that very large amounts of data are produced when collecting data from a number of users over time. This is undesirable for a number of reasons. First, larger amounts of storage are necessary to store the user data 301 and may overwhelm the optimizer within the compiler. Also, as the amount of user data 301 increases, an exponentially larger amount of data is necessary to continue to increase the amount of coverage of blocks of code. Therefore, it is desirable for the user data 301 to be reduced in such a way that the overall amount of data necessary to achieve sufficient coverage of the blocks of code is kept relatively manageable without sacrificing block coverage or accuracy.

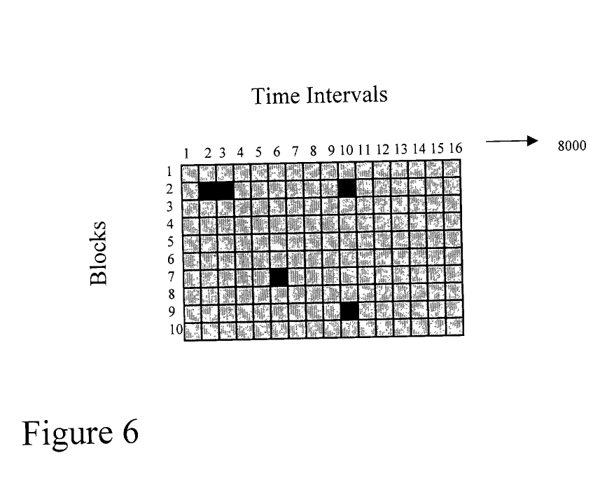

A data reduction technique that is effective in this regard uses three steps to reduce the amount of user data without sacrificing block coverage. The first step is to retain whole intervals of user data up to a predetermined number of time intervals. The amount of time for which all data is retained should be set such that the most frequently used blocks of code can be optimized as if no data reduction were taking place. For instance, the data in FIG. 6 is for 10 blocks of code that are monitored in one-second intervals with all data being retained until the predetermined number of time intervals. In this example, the number of time intervals to retain all data without any data reduction steps is set to 8000 intervals. It can be seen from the user data that block 2 was in use during the second, third and tenth intervals, but was not being used in any other interval in the first sixteen intervals. Likewise, block 7 was in use during the sixth interval and block 9 was in use during the tenth interval. Blocks 1, 3-6, 8 and 10 are not used at all during the shown time intervals. Yet, all data will be retained for the first 8000 intervals of time regardless of how frequently the monitored blocks are used.

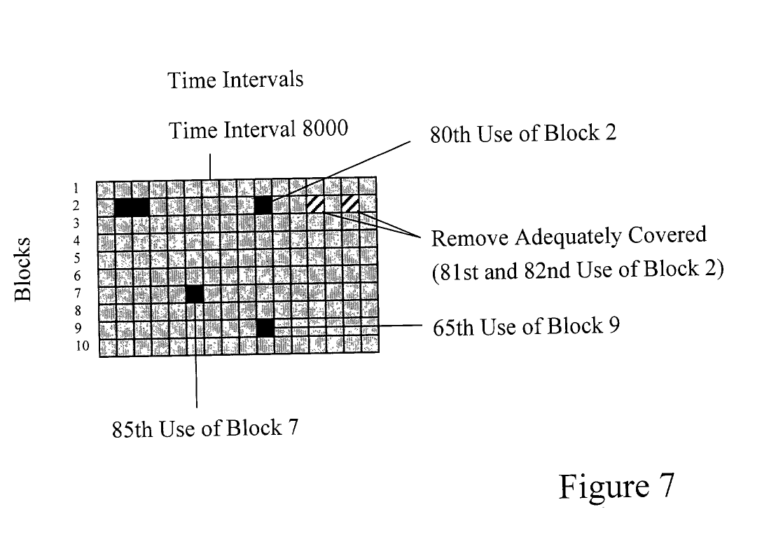

Once user data up to a predetermined number of intervals has been retained, a limit on the amount of intervals a block is monitored is set. The limit should be set such that a sufficient number of data points are kept to accurately predict the behavior of the block while excess data points that will add little to no further understanding of the block's behavior are discarded. FIG. 7 shows reducing the amount of user data by setting a limit on the amount of recorded uses retained for each block of code once the whole interval limit has been reached. For this example, the limit on the amount of recorded uses is set to 80. As previously discussed with respect to FIG. 5, all data until interval 8000 is retained. Thus, the 85^{th} use of block 7 indicated at interval 7999 will be recorded despite being over the 80^{th} use because it is within the 8000 interval limit set to retain all user data. However, after the 8000^{th} interval, the amount of user data for each block is limited to 80 uses. Thus, the 66^{th} use for block 9 at interval 8003 will be retained as well as the 80^{th} use for block 2 at interval 8003 because they are still within the 80-uses limit. However, the uses of block 2 at intervals 8006 and 8008 will be removed from the user data because they are outside the 80-use limit, being the 81^{st} and 82^{nd} uses of block 2, and past the 8000 interval limit where all data is retained.

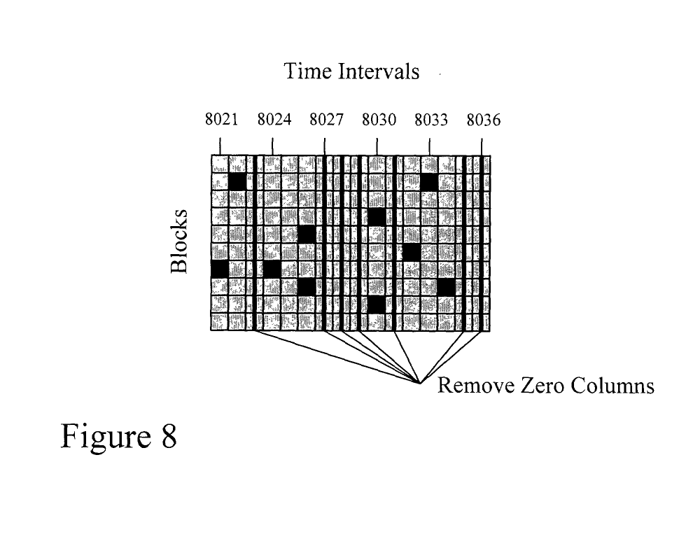

Lastly, once the whole interval limit and coverage limits have been applied, time intervals that contain no user data regarding block use for blocks still being monitored are removed. FIG. 8 shows user data for block uses sometime after the 8000^{th} interval chosen previously as the point up until which all data is retained. Also, it is assumed all block uses shown in this figure are for blocks that have not reached the use limit set previously at 80 uses. Under such circumstances, the intervals of time that show no uses for the blocks still being monitored may be discarded. Accordingly, FIG. 7 shows removing time intervals 8023, 8027, 8028, 8029, 8035, and 8036 because they contain no data indicating block use.

### Profile Propagation

Propagation of the user data 301 taken from a prior build can be accomplished using a binary matching technique. Binary matching utilizes a mapping between a first, prior build of a program 302 and the second, current build of a program 308 in order to translate data into a form that accurately predicts the behavior of the current build 308. For instance, Binary Matching Tool for Stale Profile Propagation (BMAT) is a binary matching technique wherein two versions of a binary program are compared such that matches between their procedures, code blocks, and data blocks can be identified and used to propagate stale, or prior, data such that it can be used to optimize the current build of the program without knowledge of source code changes.

BMAT operates by first attempting to find a one-to-one mapping between a procedure of the previous build and a procedure of the current build based on four stages of processing. First, procedures with identical procedure names are considered a match. Second, a hash value is computed for each block in a procedure using the opcodes and operands of its instructions at different levels of fuzziness (greater fuzziness corresponds to less information and less specificity). The hash values for each block in a procedure are then used to calculate, sensitive to the order of blocks, a hash value for the procedure. Procedures with identical hash values are assumed matches. Third, procedures with names that only differ by a small number of characters are analyzed at the block level by utilizing a single pass version of code block matching as described below. If a high percentage of blocks match within the procedure, the procedures are assumed a match. Lastly, this same procedure is performed on all remaining unmatched procedures. This first level of mapping does not take into consideration added or deleted procedures, or procedures that have had extensive changes to them from the first to second build.

Once the first mapping is complete, each procedure matched above is then mapped on the individual block level using two different methods for data blocks and code blocks. Data blocks are matched first by calculating a hash value for the data blocks and matching them with data blocks with the identical hash value. Next, unmatched blocks are matched according to their approximate position in the program and their size. Code blocks in the previously matched procedures are matched by assigning a hash value to each block utilizing multiple passes at different levels of fuzziness. If the two blocks within the procedure have the same hash value, it is assumed they are a match. Subsequently, for blocks within the procedure that aren't matched, a static control-flow analysis is performed such that blocks of code in the matched procedures that behave similarly are matched.

BMAT is described in more detail in Wang, Z., Pierce, K., and McFarling, S., BMAT—A Binary Matching Tool for Stale Profile Propagation, The Journal of Instruction-Level Parallelism (JILP) Vol. 2, May 2000, hereby incorporated by reference.

### Combining Scenario and User Data

Prior to optimization, the current build of the program 308 is instrumented 309 as well, such that scenarios 311 can be used to execute the instrumented version of the program and create scenario data 312. The user data 301 produced previously is then provided along with the scenario data 312 to a compiler such that the current build of the program can be optimized 513 and compiled according to the user data 301 and the scenario data 312.

Ideally, the user data 301 is combined with the scenario data 312 in a phased format such that the optimizer within the compiler first considers the scenario data 312 and then subsequently the user data 301 when positioning blocks of code. However, it should be recognized that the user data 301 and scenario data 312 could be utilized by the optimizer within the compiler in any order or manner desired.

### Example of Reality-Based Optimization

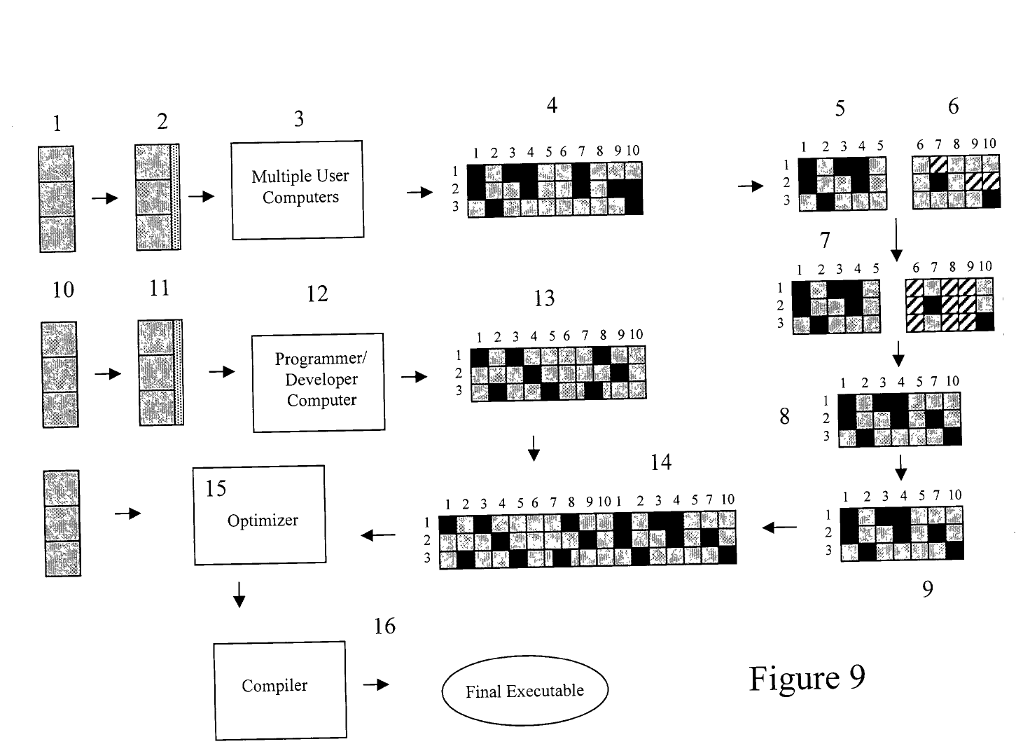

FIG. 9 is a data flow chart that describes the optimization and data reduction techniques described above being applied to three blocks of code. For purposes of illustration, the number of intervals for retaining all data is set to 5 time intervals, and the limit on the number of uses for each block to be retained is set to 4. Three blocks of code of a build A are shown at step 1. These blocks of code are altered to produce instrumented versions of the blocks as shown in step 2 and provided to a number of users in step 3 in executable form and used in a normal manner. The execution of the instrumented blocks creates and stores the user data shown in step 4 describing the run-time behavior of the blocks of code.

Once a sufficient amount of user data is attained, the user data is reduced using the data reduction technique described previously. First, all data is automatically retained up to the 5^{th} time interval without any data reduction, as seen in step 5. Next, any data showing use of a block beyond the 5^{th} time interval and beyond the 3-use limit on data collection for each block is removed. Thus, step 6 shows the (4^{th}) use of block 1 at time interval 7 being discarded as are the (4^{th} and 5^{th}) uses of block 2 at the 9^{th} and 10^{th} time intervals. The (3^{rd}) use of block 2 at time interval 7 and the (2^{nd}) use of block 3 at time interval 10 are retained because they are under the 3-use limit.

Lastly, as shown in step 7, any time intervals past the 5^{th} interval that do not contain any data indicating data use are removed. Therefore, the 6^{th}, 8^{th}, and 9^{th} time intervals are discarded because they no longer contain any data regarding use of the blocks monitored. Thus, the reduced data shown in step 8 is produced. By this time in the process, a substantial amount of time (anywhere from days to months) has passed while user data was being collected from the real users. Therefore, the blocks of code from build A used to collect the user data have most likely been revised and updated into a more current build B. Thus, the user data collected in step 8 is propagated to the data shown in step 9 using a binary matching technique such as BMAT so that it accurately represents the behavior of the blocks of code from the current build B of the program.

The blocks of code from the current build B are shown in step 10. These blocks are instrumented in step 11 similar to how the blocks of code from previous build A were instrumented in step 2. Thereafter, an executable file containing the instrumented blocks of code is executed by the programmer or driven by scenarios as shown in step 12 in order to produce the scenario data of step 13. The propagated, reduced user data of step 9 is then combined with the scenario data of step 13 in a phased format such that the scenario data precedes the user data, as shown in step 14. The original blocks of code of current build B are then provided to an optimizer along with the combined scenario and user data as shown in step 15. The blocks of code of current build B are then optimized based on the provided combined user and scenario data and a compiler produces a final, optimized executable as shown in step 16.

### Exemplary Operating Environment

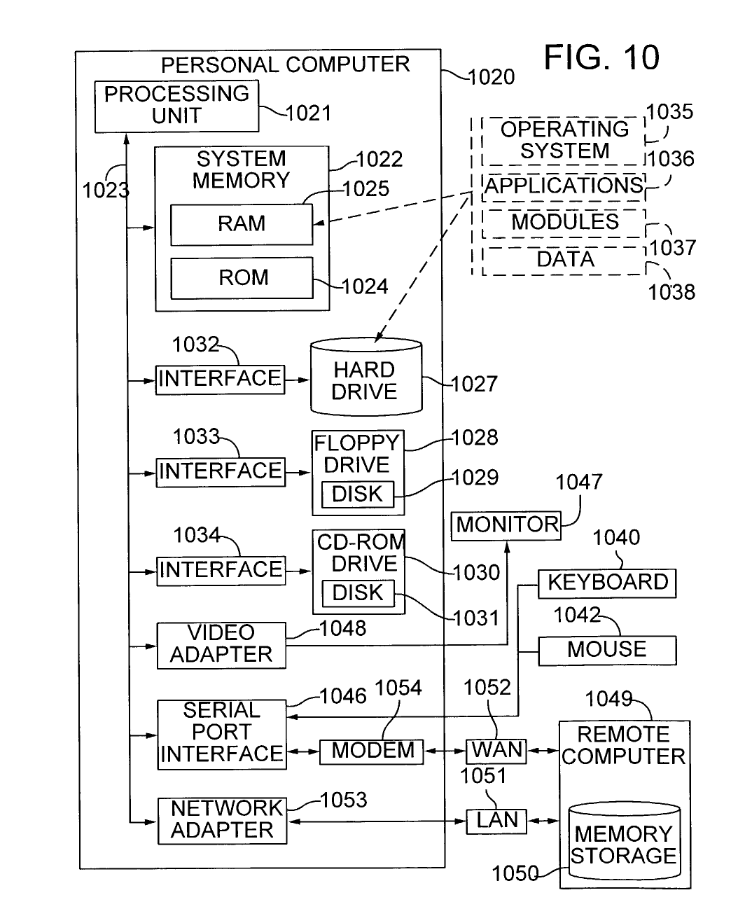

FIG. 10 illustrates an example of a computer system that serves as an operating environment for reality-based optimization of software. The computer system includes a personal computer 1020, including a processing unit 1021, a system memory 1022, and a system bus 1023 that interconnects various system components including the system memory to the processing unit 1021. The system bus may comprise any of several types of bus structures including a memory bus or memory controller, a peripheral bus, and a local bus using a bus architecture such as PCI, VESA, Microchannel (MCA), ISA and EISA, to name a few. The system memory includes read only memory (ROM) 1024 and random access memory (RAM) 1025. A basic input/output system 1026 (BIOS), containing the basic routines that help to transfer information between elements within the personal computer 1020, such as during start-up, is stored in ROM 1024. The personal computer 1020 further includes a hard disk drive 1027, a magnetic disk drive 1028, e.g., to read from or write to a removable disk 1029, and an optical disk drive 1030, e.g., for reading a CD-ROM disk 1031 or to read from or write to other optical media. The hard disk drive 1027, magnetic disk drive 1028, and optical disk drive 1030 are connected to the system bus 1023 by a hard disk drive interface 1032, a magnetic disk drive interface 1033, and an optical drive interface 1034, respectively. The drives and their associated computer-readable media provide nonvolatile storage of data, data structures, computer-executable instructions (program code such as dynamic link libraries, and executable files), etc. for the personal computer 1020. Although the description of computer-readable media above refers to a hard disk, a removable magnetic disk and a CD, it can also include other types of media that are readable by a computer, such as magnetic cassettes, flash memory cards, digital video disks, Bernoulli cartridges, and the like.

A number of program modules may be stored in the drives and RAM 1025, including an operating system 1035, one or more application programs 1036, other program modules 1037, and program data 1038. A user may enter commands and information into the personal computer 1020 through a keyboard 1040 and pointing device, such as a mouse 1042. Other input devices (not shown) may include a microphone, joystick, game pad, satellite dish, scanner, or the like. These and other input devices are often connected to the processing unit 1021 through a serial port interface 1049 that is coupled to the system bus, but may be connected by other interfaces, such as a parallel port, game port or a universal serial bus (USB). A monitor 1047 or other type of display device is also connected to the system bus 1023 via an interface, such as a display controller or video adapter 1048. In addition to the monitor, personal computers typically include other peripheral output devices (not shown), such as speakers and printers.

The personal computer 1020 may operate in a networked environment using logical connections to one or more remote computers, such as a remote computer 1049. The remote computer 1049 may be a server, a router, a peer device or other common network node, and typically includes many or all of the elements described relative to the personal computer 1020, although only a memory storage device 1050 has been illustrated in FIG. 10. The logical connections depicted in FIG. 10 include a local area network (LAN) 1051 and a wide area network (WAN) 1052. Such networking environments are commonplace in offices, enterprise-wide computer networks, intranets and the Internet.

When used in a LAN networking environment, the personal computer 1020 is connected to the local network 1051 through a network interface or adapter 1053. When used in a WAN networking environment, the personal computer 1020 typically includes a modem 1054 or other means for establishing communications over the wide area network 1052, such as the Internet. The modem 1054, which may be internal or external, is connected to the system bus 1023 via the serial port interface 1046. In a networked environment, program modules depicted relative to the personal computer 1020, or portions thereof, may be stored in the remote memory storage device. The network connections shown are merely examples and other means of establishing a communications link between the computers may be used.

Having illustrated and described the principles of the illustrated embodiments, it will be apparent to those skilled in the art that the embodiments can be modified in arrangement and detail without departing from such principles.

In view of the many possible embodiments, it will be recognized that the illustrated embodiments include only examples and should not be taken as a limitation on the scope of the invention. Rather, the invention is defined by the following claims. I therefore claim as the invention all such embodiments that come within the scope of these claims.

I claim:

1. A method for optimizing software on a computer, the method comprising:
distributing an instrumented version of software to a plurality of users for creating user data describing behavior of the instrumented version of software on user computers during execution;
collecting the user data created by the instrumented versions distributed to the users;
collecting scenario data that describes the behavior of an instrumented version of software driven by programmer-authored scenarios, scripts, or similar sources; and
optimizing the software using the user data and the scenario data.

2. The method of claim 1 wherein user data is only used to optimize blocks of code within the software not optimized using scenario data.

3. The method of claim 1 wherein only user data for blocks of code within the software having no user data or scenario data available from other sources is collected from the plurality of users.

4. The method of claim 1 wherein all user data is collected up to a predetermined time, after which the amount of user data collected is limited.

5. The method of claim 1 wherein collecting user data from the instrumented versions distributed to the users comprises:
retaining all user data collected during a predetermined number of time intervals; and
subsequent to the predetermined number of time intervals:
retaining only user data for blocks of code within the software that have less than a predetermined amount of user data associated with them; and
discarding user data during intervals in which no blocks of code within the software were used.

6. The method of claim 1 wherein user data associated with blocks of code within the software also associated with scenario data is not used to optimize the software.

7. The method of claim 1 wherein the user data used to optimize the code comprises user data from a current build of software and user data from a previous build of the software.

8. The method of claim 1 wherein the scenario data is created from a current build of the software and the user data is created from a previous build of the software.

9. The method of claim 8 wherein the user data created from a previous build of the software is propagated to the current build.

10. The method of claim 9 wherein the user data created from a previous build of the software is propagated to the current build using a binary matching technique.

11. A method of optimizing software comprising:
modifying code representing the software such that when compiled and executed on a computer user data is produced that describes the behavior of the code during execution;
distributing an executable file produced from the modified code to a plurality of users;
collecting the user data produced when the executable file is used by the plurality of users;
collecting scenario data that describes the behavior of an instrumented version of software driven by programmer-authored scenarios, scripts, or similar sources;
and recompiling code representing the software using the user data and the scenario data to optimize the code.

12. The method of claim 11 wherein user data is only used to optimize code not optimized using scenario data.

13. The method of claim 11 wherein the code is modified such that when compiled and executed on a computer user data is produced only for code having no user data or scenario data available from other sources.

14. The method of claim 11 wherein all user data is collected up to a predetermined time, after which the amount of user data collected is limited.

15. The method of claim 11 wherein collecting the user data produced further comprises:
discarding user data during intervals in which no blocks of code were used;
using all user data collected during a predetermined number of time intervals; and
thereafter, using only user data for blocks of code that have less than a predetermined amount of user data associated with them.

16. The method of claim 11 wherein user data associated with blocks of code also associated with scenario data is not used to optimize the code.

17. The method of claim 11 wherein the scenario data is created from a current build of the executable file and the user data is created from a previous build of the executable file.

18. The method of claim 11 wherein the user data used to optimize the code comprises user data from a current build of the executable file and user data from a previous build of the executable file.

19. The method of claim 18 wherein the user data from a previous build of the executable file is propagated to the current build.

20. The method of claim 19 wherein the user data from a previous build of the executable file is propagated to the current build using a binary matching technique.

21. A system of optimizing software comprising:
a means of collecting user data, wherein the user data represents code block usage of software when used by a plurality of users;
a means for combining the user data with scenario data, wherein the scenario data represents code block usage of the software when driven by programmer-authored scenarios, scripts, or similar sources; and
a means for using the user data and the scenario data to optimize software.

22. The method of claim 21 wherein the user data is only used to optimize blocks of code within the software not optimized using scenario data.

23. The system of claim 21 wherein user data is collected by distributing an instrumented version of the software to a plurality of users.

24. The system of claim 21 user data is collected only for blocks of code having no user data or scenario data available from other sources.

25. The system of claim 21 wherein the user data and scenario data are provided to a compiler operable to create an optimized version of the software using the user data and scenario data.

26. The method of claim 21 wherein all user data is collected up to a predetermined time, after which the amount of user data collected is limited.

27. The method of claim 21 wherein collecting user data comprises:
retaining all user data collected during a predetermined number of time intervals; and
subsequent to the predetermined number of time intervals:
retaining only user data for blocks of code that have less than a predetermined amount of user data associated with them; and
discarding user data during intervals in which no blocks of code were used.

28. The system of claim 21 wherein user data associated with blocks of code also associated with scenario data is not used to optimize the code.

29. The method of claim 21 wherein the scenario data is created from a current build of the software and the user data is created from a previous build of the software.

30. The system of claim 29 wherein the data from a previous build of the executable file is propagated to the current build.

31. The system of claim 30 wherein the data from a previous build of the executable file is propagated to the current build using a binary matching technique.

32. A system for optimizing software comprising:
an instrumentation injector for creating instrumented versions of software;
a profile combiner for combining data describing the behavior of an instrumented version of software on a number of computers into user data;
an optimizer for entering the user data and for entering scenario data, the scenario data representing behavior of the software when driven by programmer-authored scenarios, scripts, or similar sources; and
a compiler for creating an executable from the computer code based on the user data and the scenario data entered into the optimizer.

33. The system of claim 32 further comprising a data reduction tool for filtering user data to reduce its size.

34. The system of claim 33 wherein the user data is filtered by discarding user data during time intervals in which no blocks of code within the software were used.

35. The system of claim 33 wherein filtering user data comprises retaining all user data collected during a predetermined number of time intervals.

36. The system of claim 33 wherein the user data is filtered by using only user data for blocks of code within the software that have less than a predetermined amount of user data associated with them.

37. The system of claim 32 wherein user data is only used to optimize code not optimized using scenario data.

38. The system of claim 32 wherein the scenario data and the user data are entered into the optimizer in a phased format such that the scenario data is considered prior to the user data.

39. The system of claim 32 wherein the user data is collected by distributing an instrumented version of the software to the plurality of users.

40. The system of claim 39 wherein the instrumented version of the software only collects user data for blocks of code within the software that have no user data or scenario data available from other sources.

41. The system of claim 32 further comprising a propagation tool for propagating user data from a previous build of software to a current build.

42. The system of claim 41 wherein the propagation tool uses a binary matching technique.

43. A computer-readable medium having stored thereon a software profile data structure comprising:
data indicating a block of code was accessed during execution of a program during a given time interval up to a predetermined number of time intervals; and
data indicating a block of code was accessed during execution of program during a given time interval, wherein the data is limited to only those accesses occurring prior to a predetermined number of recorded accesses of the block.

44. The computer-readable medium of claim 43 wherein at least one recorded access of a block is present for each time interval occurring subsequent to the predetermined number of time intervals.
